(19) United States
(12) Patent Application Publication
(10) Pub. No.: US 2020/0380340 A1
(43) Pub. Date: Dec. 3, 2020

(54) Byzantine Tolerant Gradient Descent For Distributed Machine Learning With Adversaries

(71) Applicant: ECOLE POLYTECHNIQUE FEDERALE DE LAUSANNE (EPFL), Lausanne (CH)

(72) Inventors: Peva Blanchard, Lausanne (CH); El Mahdi El Mhamdi, Lausanne (CH); Rachid Guerraoui, Aubonne (CH); Julien Stainer, Lausanne (CH)

(21) Appl. No.: 16/767,802

(22) PCT Filed: Nov. 29, 2017
(86) PCT No.: PCT/EP2017/080806

§ 371 Date: May 28, 2020

(51) Int. Cl. G06N 3/04; G06N 20/20; G06F 17/18

(52) U.S. Cl. CPC G06N 3/0472; G06F 17/18; G06N 3/0454; G06N 20/20

(57) ABSTRACT

The present application concerns a computer-implemented method for training a machine learning model in a distributed fashion, using Stochastic Gradient Descent, SGD, wherein the method is performed by a first computer in a distributed computing environment and comprises performing a learning round, comprising broadcasting a parameter vector to a plurality of worker computers in the distributed computing environment, receiving an estimate update vector (gradient) from all or a subset of the worker computers, wherein each received estimate vector is either an estimate of a gradient of a cost function, or an erroneous vector, and determining an updated parameter vector for use in a next learning round based only on a subset of the received estimate vectors. The method aggregates the gradients while guaranteeing resilience to up to half workers being compromised (malfunctioning, erroneous or modified by attackers).

### CLAIM OF PRIORITY

This application claims priority to International Application No. PCT/EP2017/080806, filed Nov. 29, 2017, the content of which is incorporated herein by reference in its entirety.

### TECHNICAL FIELD

The present invention generally relates to the field of machine learning and distributed implementations of stochastic gradient descent, and more particularly to a method for training a machine learning model, as well as systems and computer programs for carrying out the method.

### THE PRIOR ART

Nowadays, machine learning is increasingly popular for computing tasks where designing and programming explicit algorithms with good performance is difficult or infeasible, e.g. in applications such as email filtering, detection of network intruders or malicious insiders working towards a data breach, optical character recognition (OCR), computer vision, pattern recognition and artificial intelligence. Generally speaking, machine learning employs algorithms that can learn from and make predictions on data, thereby giving computers the ability to learn without being explicitly programmed.

The increasing amount of data available (see reference [6]) together with the growing complexity of machine learning models (see reference [27]) has led to learning schemes that require vast amounts of computational resources. As a consequence, many industry-grade machine learning implementations are nowadays distributed among multiple, i.e. possibly thousands of, computers (see reference [1]). For example, as of 2012, Google reportedly used 16,000 processors to train an image classifier (see reference [22]). More recently, attention has been given to federated learning and federated optimization settings with a focus on communication efficiency (see references [15, 16, 23]).

However, distributing a computation over several machines (so-called worker processes) induces a higher risk of failures. Such failures include crashes and computation errors, stalled processes, biases in the way the data samples are distributed among the processes, but also attackers trying to compromise the entire system. Therefore, systems are needed that are robust enough to tolerate so-called “Byzantine” failures, i.e., completely arbitrary behaviors of some of the processes (see reference [17]).

One approach to mask failures in distributed systems is to use a state machine replication protocol (see reference [26]), which requires, however, state transitions to be applied by all worker processes. In the case of distributed machine learning, this constraint can be translated in two ways: either (a) the processes agree on a sample of data based on which they update their local parameter vectors, or (b) they agree on how the parameter vector should be updated. In case (a), the sample of data has to be transmitted to each process, which then has to perform a heavyweight computation to update its local parameter vector. This entails communication and computational costs that defeat the entire purpose of distributing the work. In case (b), the processes have no way to check if the chosen update for the parameter vector has indeed been computed correctly on real data. In other words, a byzantine process could have proposed the update and may easily prevent the convergence of the learning algorithm. Therefore, neither of these solutions is satisfactory in a realistic distributed machine learning setting.

Many learning algorithms today rely on Stochastic Gradient Descent (SGD) (see references [4, 13]). SGD may be used e.g. for training neural networks (see reference [13]), regression (see reference [34]), matrix factorization (see reference [12]) and/or support vector machines (see reference [34]). Typically, a cost function depending on a parameter vector is minimized based on stochastic estimates of its gradient.

Distributed implementations of SGD (see reference [33]) typically take the following form: A single parameter server is in charge of updating the parameter vector, while worker processes perform the actual update estimation, based on the share of data they have access to. More specifically, the parameter server executes learning rounds, during each of which the parameter vector is broadcast to the workers. In turn, each worker computes an estimate of the update to apply (an estimate of the gradient), and the parameter server aggregates all results to finally update the parameter vector. Nowadays, this aggregation is typically implemented through averaging (see reference [25]), or variants of averaging (see references [33, 18, 31]).

Until now, distributed machine learning frameworks have largely ignored the possibility of failures, especially of arbitrary (i.e., byzantine) ones. Causes of such failures may include software bugs, network asynchrony, biases in local datasets, as well as attackers trying to compromise the entire system.

In particular, the inventors have observed that no linear combination of the updates proposed by the workers (such as averaging according to the currently known approaches) can tolerate a single Byzantine worker. Basically, a single Byzantine worker can force the parameter server to choose any arbitrary vector, even one that is too large in amplitude or too far in direction from the other vectors. This way, the Byzantine worker can prevent any classic averaging-based approach to converge, so that the distributed system delivers an incorrect result, or stalls or crashes completely in the worst case.

As an alternative to linear averaging, a non-linear, e.g. squared-distance-based aggregation rule, that selects among the proposed vectors the vector “closest to the barycenter” (e.g. by taking the vector that minimizes the sum of the squared distances to every other vector), might look appealing. Yet, such a squared-distance-based aggregation rule tolerates only a single Byzantine worker. Two Byzantine workers can collude, one helping the other to be selected, by moving the barycenter of all the vectors farther from the “correct area”.

Still another alternative would be a majority-based approach which looks at every subset of n−f vectors (n being the overall number of workers and f being the number of Byzantine workers to be tolerated), and considering the subset with the smallest diameter. While this approach is more robust to Byzantine workers that propose vectors far from the correct area, its exponential computational cost is prohibitive, which makes this method unfeasible in practice.

In summary, all known distributed machine learning implementations are either not fault tolerant at all, i.e. they output incorrect results in the presence of workers delivering erroneous vectors, or they are very inefficient in terms of computational cost.

It is therefore the technical problem underlying the present invention to provide a distributed machine learning implementation which is both fault tolerant, i.e. which delivers correct results even in the presence of arbitrarily erroneous workers, and efficient, i.e. less computationally intensive, thereby at least partly overcoming the above explained disadvantages of the prior art.

### SUMMARY OF THE INVENTION

This problem is solved by the present invention as defined in the independent claims. Advantageous modifications of embodiments of the invention are defined in the dependent claims.

In one embodiment, a computer-implemented method for training a machine learning model using Stochastic Gradient Descent (SGD) is provided. The method is performed by a first computer in a distributed computing environment and may comprise performing a learning round comprising broadcasting a parameter vector to a plurality of worker computers in the distributed computing environment, and receiving an estimate vector from all or a subset of the worker computers. Each received estimate vector may either be an estimate of a gradient of a cost function (if it is delivered by a correct worker), or an erroneous vector (if it is delivered by an erroneous, i.e. “byzantine” worker). If the first computer has not received an estimate vector from a given worker computer, the first computer may use a default estimate vector for that given worker computer. The method further determines an updated parameter vector for use in a next learning round.

The determination may be based only on a subset of the received estimate vectors. This way, the method differs from the above-explained averaging approach which takes into account all vectors delivered by the workers, even the erroneous ones. In contrast to this known approach, the present method operates only on a subset of the received estimate vectors. This greatly improves the fault tolerance while leading to a particularly efficient implementation, as will be explained further below.

In one aspect, determining the updated parameter vector precludes the estimate vectors which have a distance greater than a predefined maximum distance to the other estimate vectors. Accordingly, the first computer does not aggregate all estimate vectors received from the worker computers (as in the known averaging approach), but disregards vectors that are too far away from the other vectors. Since such outliers are erroneous with a high likelihood, this greatly improves the fault tolerance of the method in an efficient manner.

Determining the updated parameter vector may comprise computing a score for each worker computer, the score representing the sum of (squared) distances of the estimate vector of the worker computer to a predefined number of its closest estimate vectors. Preferably, n is the total number of worker computers, f is the number of erroneous worker computers returning an erroneous estimate vector, and the predefined number of closest estimate vectors is n−f.

Accordingly, the method advantageously combines the intuitions of the above-explained majority-based and squared-distance-based methods, so that the first computer selects the vector that is somehow the closest to its n−f neighbors, namely the estimate vector that minimizes the sum of squared distances to its n−f closest vectors.

This way, the method satisfies a strong resilience property capturing sufficient conditions for the first computer's aggregation rule to tolerate f. Byzantine workers. Essentially, to guarantee that the cost will decrease despite Byzantine workers, the vector output chosen by the first computer should (a) point, on average, to the same direction as the gradient and (b) have statistical moments (preferably up to the fourth moment) bounded above by a homogeneous polynomial in the moments of a correct estimator of the gradient. Assuming 2f+2<n, the present method satisfies this resilience property and the corresponding machine learning scheme converges.

A further important advantage of the method is its (local) time complexity (O(n²·d), linear in the dimension of the gradient, where d is the dimension of the parameter vector (note that in modern machine learning, the dimension d of the parameter vector may take values in the hundreds of billions; see reference [30]).

Preferably, the score may be computed for each worker computer i as s(i)=Σ_{i→j}∥Vᵢ−Vⱼ∥², wherein the sum runs over the n−f−2 closest vectors to Vᵢ, wherein n is the total number of worker computers, wherein f is the number of erroneous worker computers returning an erroneous estimate vector, and wherein i→j denotes the fact that an estimate vector Vⱼ belongs to the n−f−2 closest estimate vectors to Vᵢ.

Alternatively, the score may be computed for each worker computer i as s(i)=Σ_{i→j}∥Vᵢ−Vⱼ∥², wherein the sum runs over the n−f−k closest vectors to Vᵢ, wherein k is a predefined integer that can take values from −f−1 to +n−f−1, wherein n is the total number of worker computers, wherein f is the number of erroneous worker computers returning an erroneous estimate vector, and wherein i→j denotes the fact that an estimate vector Vⱼ belongs to the n−f−k closest estimate vectors to Vᵢ. This way, the designer can initially setup the parameter k to 2 if the suspicion on f malicious workers is strong.

Note that this alternative differs from the one described above essentially only in that the parameter k is set to 2 in the first alternative. This setting of k=2 has the benefit of being provably Byzantine-resilient (as will be shown further below) even when no knowledge is provided on the suspected f machines. If evidence is provided that only part of those f machine are to be strongly suspected, while the others are only weakly suspected, (for instance when some lack a critical operating system (OS) security update while the other only missed some minor security update), then k can be made smaller (and negative) to ultimately reach −f−1 when only one machine is strongly suspected. On the opposite, when strong suspicion is there, the designer can prefer relying only on the very closest neighbors of i and set k to higher (positive) values, to ultimately rely only on the closest neighbour.

Moreover, the score may be computed for each worker computer i as

$$s ( i ) = \frac{1}{K ( i )} {\sum }_{i \to j} {‖ {V}_{i} - {V}_{j} ‖}^{a} ,$$

wherein a is a predefined positive integer and K(i) is a normalization factor, wherein n is the total number of worker computers, wherein f is the number of erroneous worker computers returning an erroneous estimate vector, and wherein i→j denotes the fact that an estimate vector Vⱼ belongs to the n−f−k closest estimate vectors to Vᵢ. This way, a can be set to 1 when a Median-based solution is desired (note that when a=1 and k=−f−1, the method becomes exactly the Medoid, a=1 and k≠f−1 corresponds to what can be seen as a Mediod-like method “Medoid-Krum” (see further below)). Alternatively, when a solution that is based on higher order moments is the goal, a can be set to take values higher than 1, for instance, a=2 (the standard method (“Krum”)) corresponds to controlling the growth of the second moment (variance) between the aggregated gradient and the real gradient, and similarly, a=m larger or equal to 3 will lead to a better control of the m-th order moment.

The present invention provides various ways of aggregating the estimate vectors received from the worker computers, all of which will be described in more detail further below:

For example, the method may comprise selecting the estimate vector of the worker computer having the minimal score. This approach is also referred to herein as “Krum”. If two or more worker computers have the minimal score, the method may select the estimate vector of the worker computer having the smallest identifier.

As another example, the method may select two or more of the estimate vectors which have the smallest scores, and compute the average of the selected estimate vectors. This approach is also referred to herein as “Multi-Krum”. The number of selected estimate vectors may be selected to set a trade-off between convergence speed and resilience to erroneous worker computers. For example, the number of selected estimate vectors may be n−f, wherein n is the total number of worker computers and f is the number of erroneous worker computers returning an erroneous estimate vector.

In yet another example, determining the updated parameter vector may comprise computing the Medoid of the received estimate vectors, or a variant of the Medoid comprising minimizing the sum of non-squared distances over a subset of neighbors of a predetermined size. This approach is also referred to herein as “Medoid Krum”.

In still another example, determining the updated parameter vector may comprise computing the average of the received estimate vectors with a probability p or selecting the received estimate vector that minimizes the sum of squared distances to a predetermined number of closest estimate vectors with a probability 1−p, wherein p decreases with each learning round. This approach is also referred to herein as “1−p-Krum”.

Generally, the machine learning model may comprise a neural network, regression, matrix factorization, support vector machine and/or any gradient-based optimizable learning model. The method may be used for any computation-intensive task, such as without limitation training a spam filter, email filtering, recommender system, natural language processing, detection of network intruders or malicious insiders working towards a data breach, optical character recognition (OCR), computer vision, pattern recognition, image classification and/or artificial intelligence.

The present invention is also directed to a computer in a distributed computing environment, wherein the computer is adapted for performing any of the methods disclosed herein. For example, a computer is provided in a distributed computing environment for training a machine learning model using Stochastic Gradient Descent (SGD), wherein the computer comprises a processor configured for performing a learning round, the learning round comprising broadcasting a parameter vector to a plurality of worker computers in the distributed computing environment, receiving an estimate vector from all or a subset of the worker computers, wherein each received estimate vector is either an estimate of a gradient of a cost function, or an erroneous vector, and determining an updated parameter vector for use in a next learning round based only on a subset of the received estimate vectors.

The invention also concerns a distributed computing environment comprising a first computer as disclosed above and a plurality of worker computers.

Lastly, a computer program and non-transitory computer-readable medium is provided for implementing any of the methods disclosed herein.

### SHORT DESCRIPTION OF THE DRAWINGS

In the following detailed description, presently preferred embodiments of the invention are further described with reference to the following figures:

FIG. 1: Gradient estimates computed by correct and byzantine workers around an actual gradient;

FIG. 2: A geometric representation of estimates computed by correct and byzantine workers around an actual gradient;

FIG. 3: A geometric representation of a convergence analysis;

FIG. 4: A cross-validation error evolution with rounds, respectively in the absence and in the presence of 33% byzantine workers;

FIG. 5: A cross-validation error at around 500 when increasing a mini-batch size;

FIG. 6: A cross-validation error evolution with rounds;

FIG. 7: A comparison of averaging aggregation with 0% byzantine workers to Multi-Krum facing 45% byzantine workers;

FIG. 8: A test accuracy of the 500 rounds as a function of the mini-batch size for an averaging aggregation with 0% byzantine workers versus multi-Krum facing 45% byzantine workers;

FIG. 9: An evolution of cross-validation accuracy with rounds for the different aggregation rules in the absence of byzantine workers;

FIG. 10: An evolution of cross-validation accuracy with rounds for the different aggregation rules in the presence of 33% Gaussian byzantine workers.

### DETAILED DESCRIPTION OF PREFERRED EMBODIMENTS

In the following, presently preferred embodiments of the invention are described with respect to methods and systems for machine learning in a distributed computing environment. In particular, an aggregation rule also referred to herein as “Krum” (i.e. a way how the parameter server may process the estimate vectors received from the worker computers) is provided, which satisfies the (α, f)-Byzantine resilience condition defined further below.

For simplicity of presentation, a version of Krum which only selects one vector among the vectors provided by the worker computers will be presented first. Other variants of Krum will be disclosed herein as well. These variants comprise “Multi-Krum ”, which interpolates between Krum and averaging, thereby allowing to mix the resilience properties of Krum with the convergence speed of averaging. Furthermore, these variants comprise “Medoid-Krum” which is inspired by the geometric median. Lastly, these variants comprise “1−p Krum”, wherein the average of proposed vectors is chosen with probability p and Krum is chosen with probability 1−p. Furthermore, as p is antiproportional to the number of learning rounds, with an increasing number of learning rounds the probability of choosing the average converges to 0, whereas the probability of choosing Krum converges to 1.

### General System Overview and Computation Flow

The distributed computing environment comprises a first computer (also referred to herein as “parameter server”) and n worker computers (also referred to herein as “workers”), similar to the general distributed system model of reference [1]. Preferably, the parameter server is assumed to be reliable. Known techniques such as state-machine replication can be used to ensure such reliability. A portion f of the workers are possibly “Byzantine”, i.e. they may deliver erroneous and/or arbitrary results (e.g. due to malfunctioning, being erroneous or being modified by an attacker).

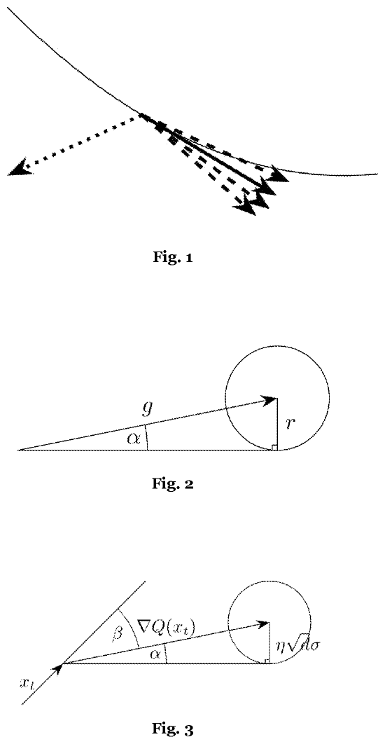

Computation is preferably divided into (theoretically infinitely many) rounds. During round t, the parameter server broadcasts its parameter vector xₜ∈R^{d} to all the workers. Each correct worker p computes an estimate Vₚ^{t}=G(xₜ, ξₚ^{t}) of the gradient ∇Q(xₜ) of the cost function Q, where ξₚ^{t} is a random variable representing, e.g., the sample (or a mini-batch of samples) drawn from the dataset. A Byzantine worker b proposes a vector V_{b}^{t} which can deviate arbitrarily from the vector it is supposed to send if it was correct, i.e., according to the algorithm assigned to it by the system developer, as illustrated in FIG. 1.

More precisely, FIG. 1 illustrates that the gradient estimates computed by correct workers (dashed arrows) are distributed around the actual gradient (solid arrow) of the cost function (curved line). A Byzantine worker can propose an arbitrary vector (dotted isolated arrow).

The communication between the parameter server and the worker computers is preferably synchronous. If the parameter server does not receive a vector value V_{b}^{t} from a given Byzantine worker b, then the parameter server may act as if it had received the default value V_{b}^{tb =0} instead.

The parameter server preferably computes a vector F(V₁^{t}, . . . , Vₙ^{t}) by applying a deterministic function F to the vectors received. F is also referred to herein as the “aggregation rule” of the parameter server. The parameter server preferably updates the parameter vector using the following SGD equation

xₜ₊₁=xₜ=γₜ·F(V₁^{t}, . . . , Vₙ^{t})

The correct (non-Byzantine) workers are assumed to compute unbiased estimates of the gradient ∇Q(xₜ). More precisely, in every round t, the vectors ᵢ^{t}'s proposed by the correct workers are preferably independent identically distributed random vectors, Vᵢ^{t}˜G(xₜ, ξᵢ^{t}) with [symbol] _{ξ}_{ᵢ}_{^{t}}G(xₜ, ξᵢ^{t})=∇Q(xₜ). This may be achieved by ensuring that each sample of data used for computing the gradient is drawn uniformly and independently (see reference [3]).

The Byzantine workers preferably have full knowledge of the system, including the aggregation rule F and/or the vectors proposed by the workers. They may furthermore collaborate with each other (see reference [21]).

As an alternative to the above-described client/server environment, embodiments of the present invention may also be realized in a peer-to-peer environment where some or all of the correct workers act as a server. For example, each worker may have a copy of the parameter vector that it updates by aggregating other workers' gradient. In each round, each worker first broadcasts its gradient, then collects other workers' gradients. On those collected gradients (including its own), the worker applies the Krum aggregating rule (or any variant thereof as disclosed herein) (as if the worker was the server), then updates its local copy of the parameter vector.

The meaning of the terms “parameter vector”, “cost function”, “sample/mini-batch” drawn from the dataset, “estimate” (of the gradient) computed by each worker and “updated parameter vector” should be apparent to those skilled in the art of machine learning and SGD. However, for the sake of illustration, consider the following use-case:

A deep learning solution is deployed and trained over several computers. The parameter vector is a vector comprising all the synaptic weights and the internal parameters of the deep learning model. The cost function is any measure of the deviation between what the deep learning model predicts, and what the computers actually observe (for example users' behavior in a recommender system versus what the recommender system predicted, or correct tagging of photos versus what the tagging system tagged in photos of a social network, or correct translations uploaded by users versus predicted translations of the model, etc.). The sample/mini-batch drawn from the dataset is a set of observed data on which the cost function and its estimated gradient can be computed, by comparing observation to prediction. Using the aggregation of the estimated gradients the parameter vector can be updated by decrementing the previous parameter vector in the direction suggested by the gradient. This way, the model achieves smaller error between observation and prediction, as evaluated by the loss function.

### Byzantine Resilience

As already explained in the background section further above, most known SGD-based learning algorithms (see references [4, 13, 12]) employ an aggregation rule which computes the average (or a closely related rule) of the input vectors. Lemma 1 below states that no linear combination of the vectors can tolerate a single Byzantine worker. In particular, averaging is not Byzantine resilient.

Lemma 1 Consider an aggregation rule Fₗᵢₙ of the form Fₗᵢₙ(V₁, . . . , Vₙ)=Σᵢ₌₁ⁿλᵢ·Vᵢ, where the λᵢ's are non-zero scalars. Let U be any vector in R^{d}. A single Byzantine worker can make F always select U . In particular, a single Byzantine worker can prevent convergence.

Proof. Immediate: if the Byzantine worker proposes

$${V}_{n} = \frac{1}{{λ}_{n}} \cdot U - {\sum }_{i = 1}^{n - 1} \frac{{λ}_{i}}{{λ}_{n}} {V}_{i} ,$$

then F=U. Note that the parameter server could cancel the effects of the Byzantine behavior by setting, e.g., λₙ to 0. This, however, requires means to detect which worker is Byzantine.

In the following, we define basic requirements on an appropriate Byzantine-resilient aggregation rule. Intuitively, the aggregation rule should output a vector F that is not too far from the “real” gradient g, more precisely, the vector that points to the steepest direction of the cost function being optimized. This can be expressed as a lower bound (condition (i)) on the scalar product of the (expected) vector F and g. FIG. 2 illustrates this geometrically. If EF belongs to the ball centered at g with radius r, then the scalar product is bounded below by a term involving sin α=r/PgP.

FIG. 2 illustrates that if ∥EF−g∥≤r then [symbol] EF,g [symbol] is bounded below by (1−sin α)PgP² where sinα=r/PgP.

It will be appreciated that the norm of a vector, ∥ . . . ∥, is denoted as P . . . P in certain formulas. Both notations shall be considered to have the same meaning.

Condition (ii) is more technical, and states that the moments of F should be controlled by the moments of the (correct) gradient estimator G . The bounds on the moments of G are classically used to control the effects of the discrete nature of the SGD dynamics (see reference [3]). Condition (ii) allows to transfer this control to the aggregation rule.

Definition 1 ((α, f) -Byzantine Resilience) Let 0≤α<π/2 be any angular value, and any integer 9≤f≤n. Let V₁, . . . , Vₙ be any independent identically distributed random vectors in R^{d}, Vᵢ˜G, with EG=g. Let B₁, . . . , B_{f} be any random vectors in R^{d}, possibly dependent on the Vᵢ's, aggregation rule F is said to be (α,f). Byzantine resilient if, for any 1=j₁< . . . <j_{f}≤n, vector

$$F = F ( {V}_{1} , … \underbrace{, {B}_{1} ,}_{{j}_{1}} … \underbrace{ , {B}_{f} ,}_{{j}_{f}} … , {V}_{n} )$$

satisfies (i) [symbol] EF,g [symbol] ≥(1−sin α)·PgP²>0 and (ii) for r=2,3,4, E∥F∥^{r} is bounded above by a linear combination of terms [symbol] ∥G∥r¹ . . . [symbol] ∥G∥^{r}^{_{n−1}} with

r₁+ . . . +rₙ₋₁=r

### The Krum Function

The barycentric aggregation rule

$${F}_{bary} = \frac{1}{n} {\sum }_{i = 1}^{n} {V}_{i}$$

can be defined as the vector in R^{d} that minimizes the sum of squared distances to the Vᵢ's Σᵢ₌₁ⁿ∥F_{bary}−Vᵢ∥² (note that removing the square of the distances leads to the geometric median, which will be discussed further below in certain Krum variants). Lemma 1 above, however, states that this approach does not tolerate even a single Byzantine failure.

One could try to select the vector U among the Vᵢ's which minimizes the sum Σ∥U−Vᵢ∥², i.e., which is “closest to all vectors”. However, because such a sum involves all the vectors, even those which are very far, this approach does not tolerate Byzantine workers: by proposing large enough vectors, a Byzantine worker can force the total barycenter to get closer to the vector proposed by another Byzantine worker.

To overcome this problem, one aspect of the present invention is to preclude the vectors that are too far away. More precisely, the Krum aggregation rule KR(V₁, . . . , Vₙ) may be defined as follows: For any i≠j, we denote by i→j the fact that Vⱼ belongs to the n−f−2 closest vectors to Vᵢ. Then, we define for each worker i, the score s(i)=Σ_{i→j}∥Vᵢ−Vⱼ∥² where the sum runs over the n−f−2 closest vectors to Vᵢ. Finally, KR(V₁, . . . , Vₙ)=Vᵢ, where i₊ refers to the worker minimizing the score, s(i₊)≤s(i) for all i. If two or more workers have the minimal score, we choose the one with the smallest identifier.

Lemma 2 The expected time complexity of the Krum Function KR(V₁, . . . , Vₙ), where V₁, . . . , Vₙ are d-dimensional vectors, is O(n²·d).

Proof. For each Vᵢ, the parameter server computes the n squared distances ∥Vᵢ−Vⱼ∥² (time (d)) O(n·d). Then the parameter server selects the first n−f−1 of these distances (expected time O(n) with Quickselect) and sums their values (time O(n·d)). Thus, computing the score of all the Vᵢ's takes O(n²·d). An additional term O(n) is required to find the minimum score, but is negligible relatively to O(n²·d)

Proposition 1 below states that, if 2f+2<n and the gradient estimator is accurate enough (i.e. its standard deviation is relatively small compared to the norm of the gradient), then the Krum function is (α, f)-Byzantine-resilient, where angle α depends on the ratio of the deviation over the gradient.

Proposition 1 Let V₁, . . . , Vₙ be any independent and identically distributed random d-dimensional vectors s.t Vᵢ˜G, with EG=g and E∥G−g∥²=dσ². Let B₁, . . . , B_{f} be any f random vectors, possibly dependent on the Vᵢ's. If 2f+2<n and η(n,f)\sqrt{d}·σ<PgP, where

$$η ( n , f ) {=}_{def} \sqrt{2 ( n - f + \frac{f \cdot ( n - f - 2 ) + {f}^{2} \cdot ( n - f - 1 )}{n - 2 f - 2} )} = \{ \begin{matrix}O ( n ) & if f = O ( n ) \\ O ( \sqrt{n} ) & if f = O ( 1 )\end{matrix} ,$$

then the Krum function Kr is (α, f)-Byzantine resilient where 0≤α<π/2 is defined by

$$sin α = \frac{η ( n , f ) \cdot \sqrt{d} \cdot σ}{PgP} .$$

The condition on the norm of the gradient, η(n,f)·\sqrt{d}·σ<PgP, can be satisfied, to a certain extent, by having the (correct) workers compute their gradient estimates on mini-batches (see reference [3]). Indeed, averaging the gradient estimates over a mini-batch divides the deviation σ by the squared root of the size of the mini-batch.

Proof (Sketch) Without loss of generality, we assume that the Byzantine vectors B₁, . . . , B_{f} occupy the last f positions in the list of arguments of Kr, i.e., KR=KR(V₁, . . . , V_{n-f}, B₁, . . . , B_{f}). Let iₒ be the index of the vector chosen by the Krum function. We focus on the condition (i) of (α, f)-Byzantine resilience (Definition 1).

Consider first the case where Vᵢ=Vᵢ∈{V₁, . . . , V_{n-f}} is a vector proposed by a correct process. The first step is to compare the vector Vᵢ with the average of the correct vectors Vⱼ such that i→j. Let δ_{c}(i) be the number of such Vᵢ's.

$$E {‖ {V}_{i} - \frac{1}{{δ}_{c} ( i )} {\sum }_{i \to correct j} {V}_{j} ‖}^{2} \leq \frac{1}{{δ}_{c} ( i )} {\sum }_{i \to correct j} E {‖ {V}_{i} - {V}_{j} ‖}^{2} \leq 2 d {σ}^{2} . \qquad ( 1 )$$

The last inequality holds because the right-hand side of the first inequality involves only vectors proposed by correct processes, which are mutually independent and follow the distribution of G.

Now, consider the case where Vᵢ=Bₖ∈{B₁, . . . , B_{f}} is a vector proposed by a Byzantine process. The fact that k minimizes the score implies that for all indices i of vectors proposed by correct processes

$${\sum }_{k \to correct j} {‖ {B}_{k} - {V}_{j} ‖}^{2} + {\sum }_{k \to byz l} {‖ {B}_{k} - {B}_{l} ‖}^{2} \leq {\sum }_{i \to correct j} {‖ {V}_{i} - {V}_{j} ‖}^{2} + {\sum }_{i \to byz l} {‖ {V}_{i} - {B}_{l} ‖}^{2} .$$

Then, for all indices i of vectors proposed by correct processes

$${‖ {B}_{k} - \frac{1}{{δ}_{c} ( k )} {\sum }_{k \to correct j} {V}_{j} ‖}^{2} \leq \frac{1}{{δ}_{c} ( k )} {\sum }_{i \to correct j} {‖ {V}_{i} - {V}_{j} ‖}^{2} + \frac{1}{{δ}_{c} ( k )} \underbrace{{\sum }_{i \to byz l} {‖ {V}_{i} - {B}_{l} ‖}^{2}}_{{D}^{2} ( i )}$$

The term D²(i) is the only term involving vectors proposed by Byzantine processes. However, the correct process i has n−f−2 neighbors and f+1 non-neighbors. Therefore, there exists a correct process ζ(i) which is farther from i than every neighbor j of i (including the Byzantine neighbors). In particular, for all l such that i→l, PVᵢ−BₗP²≤PVᵢ−V_{ζ(i)}P². Thus

$${‖ {B}_{k} - \frac{1}{{δ}_{c} ( k )} {\sum }_{k \to correct j} {V}_{j} ‖}^{2} \leq \frac{1}{{δ}_{c} ( k )} {\sum }_{i \to correct j} {‖ {V}_{i} - {V}_{j} ‖}^{2} + \frac{n - f - 2 - {δ}_{c} ( i )}{{δ}_{c} ( k )} {‖ {V}_{i} - {V}_{ζ ( i )} ‖}^{2} . \qquad ( 2 )$$

Combining equations 1, 2, and a union bound yields PEKr−gP²≤η\sqrt{d}PgP, which, in turn, implies [symbol] EKr,g [symbol] ≥(1−sin α)PgP². Condition (ii) is proven by bounding the moments of Kr with moments of the vectors proposed by the correct processes only, using the same technique as above.

The full proof is as follows:

Proof. Without loss of generality, we assume that the Byzantine vectors B₁, . . . , B_{f} occupy the last f positions in the list of arguments of Kr, i.e., KR=KR(V₁, . . . , V_{n-f}, B₁, . . . , B_{f}). An index index is correct if it refers to a vector among V₁, . . . , V_{n-f}. An index is Byzantine if it refers to a vector among B₁, . . . , B_{f}. For each index (correct or Byzantine) i, we denote by δ_{c}(i) (resp. δ_{b}(i)) the number of correct (resp. Byzantine) indices j such that i→j. We have

δ_{c}(i)+δ_{b}(i)=n−f−2

n−2f−2≤δ_{c}(i)≤n−f−2

δ_{b}(i)≤f.

We focus first on the condition (i) of (α, f)-Byzantine resilience. We determine an upper bound on the squared distance PEKr−gP². Note that, for any correct j, EVⱼ=g. We denote by i₊ the index of the vector chosen by the Krum function.

$${‖ E Kr - g ‖}^{2} \leq {‖ E ( Kr - \frac{1}{{δ}_{c} ( {i}_{*} )} {\sum }_{{i}_{*} \to correct j} {V}_{j} ) ‖}^{2} \leq E {‖ Kr - \frac{1}{{δ}_{c} ( {i}_{*} )} {\sum }_{{i}_{*} \to correct j} {V}_{j} ‖}^{2} ( Jenseninequality ) \leq {\sum }_{correct i} E {‖ {V}_{i} - \frac{1}{{δ}_{c} ( i )} {\sum }_{i \to correct j} {V}_{j} ‖}^{2} \vert ( {i}_{*} = i ) + {\sum }_{byz k} E {‖ {B}_{k} - \frac{1}{{δ}_{c} ( k )} {\sum }_{k \to correct j} {V}_{j} ‖}^{2} \vert ( {i}_{*} = k )$$

where l denotes the indicator function (l(P) equals 1 if the predicate P is true, and 0 otherwise). We examine the case i₊=i for some correct index i.

$${‖ {V}_{i} - \frac{1}{{δ}_{c} ( i )} {\sum }_{i \to correct j} {V}_{j} ‖}^{2} = {‖ \frac{1}{{δ}_{c} ( i )} {\sum }_{i \to correct j} {V}_{i} - {V}_{j} ‖}^{2} \leq \frac{1}{{δ}_{c} ( i )} {\sum }_{i \to correct j} {‖ {V}_{i} - {V}_{j} ‖}^{2} ( Jenseninequality ) E {‖ {V}_{i} - \frac{1}{{δ}_{c} ( i )} {\sum }_{i \to correct j} {V}_{j} ‖}^{2} \leq \frac{1}{{δ}_{c} ( i )} {\sum }_{i \to correct j} E {‖ {V}_{i} - {V}_{j} ‖}^{2} \leq 2 d {σ}^{2} .$$

We now examine the case i₊=k for some Byzantine index k. The fact that k minimizes the score implies that for all correct indices i

$${\sum }_{k \to correct j} {‖ {B}_{k} - {V}_{j} ‖}^{2} + {\sum }_{k \to byz l} {‖ {B}_{k} - {B}_{l} ‖}^{2} \leq {\sum }_{i \to correct j} {‖ {V}_{i} - {V}_{j} ‖}^{2} + {\sum }_{i \to byz l} {‖ {V}_{i} - {B}_{l} ‖}^{2} .$$

Then, for all correct indices i

$${‖ {B}_{k} - \frac{1}{{δ}_{c} ( k )} {\sum }_{k \to correct j} {V}_{j} ‖}^{2} \leq \frac{1}{{δ}_{c} ( k )} {\sum }_{k \to correct j} {‖ {B}_{k} - {V}_{j} ‖}^{2} \leq \frac{1}{{δ}_{c} ( k )} {\sum }_{i \to correct j} {‖ {V}_{i} - {V}_{j} ‖}^{2} + \frac{1}{{δ}_{c} ( k )} \underbrace{{\sum }_{i \to byz l} {‖ {V}_{i} - {B}_{l} ‖}^{2}}_{{D}^{2} ( i )}$$

We focus on the term D²(i). Each correct process i has n−f−2 neighbors, and f+1 non-neighbors. Thus there exists a correct worker ζ(i) which is farther from i than any of the neighbors of i. In particular, for each Byzantine index l such that i→l, ∥Vᵢ−Bₗ∥²≤∥Vᵢ−V_{ζ(i)}∥². Whence

$${‖ {B}_{k} - \frac{1}{{δ}_{c} ( k )} {\sum }_{k \to correct j} {V}_{j} ‖}^{2} \leq \frac{1}{{δ}_{c} ( k )} {\sum }_{i \to correct j} {‖ {V}_{i} - {V}_{j} ‖}^{2} + \frac{{δ}_{b} ( i )}{{δ}_{c} ( k )} {‖ {V}_{i} - {V}_{ζ ( i )} ‖}^{2} E {‖ {B}_{k} - \frac{1}{{δ}_{c} ( k )} {\sum }_{k \to correct j} {V}_{j} ‖}^{2} \leq \frac{{δ}_{c} ( i )}{{δ}_{c} ( k )} \cdot 2 d {σ}^{2} + \frac{{δ}_{b} ( i )}{{δ}_{c} ( k )} {\sum }_{correct j \neq i} E {‖ {V}_{i} - {V}_{j} ‖}^{2} \vert ( ζ ( i ) = j ) \leq ( \frac{{δ}_{c} ( i )}{{δ}_{c} ( k )} \cdot + \frac{{δ}_{b} ( i )}{{δ}_{c} ( k )} ( n - f - 1 ) ) 2 d {σ}^{2} \leq ( \frac{n - f - 2}{n - 2 f - 2} + \frac{f}{n - 2 f - 2} \cdot ( n - f - 1 ) ) 2 d {σ}^{2} .$$

Putting everything back together, we obtain

$${‖ E Kr - g ‖}^{2} \leq ( n - f ) 2 d {σ}^{2} + f \cdot ( \frac{n - f - 2}{n - 2 f - 2} + \frac{f}{n - 2 f - 2} \cdot ( n - f - 1 ) ) 2 d {σ}^{2} \leq \underbrace{2 ( n - f + \frac{f \cdot ( n - f - 2 ) + {f}^{2} \cdot ( n - f - 1 )}{n - 2 f - 2} )}_{{η}^{2} ( n , f )} d {σ}^{2}$$

By assumption, η(n, f)\sqrt{d}σ<PgP, i.e., EKr belongs to a ball centered at g with radius η(n, f)·\sqrt{d}·σ. This implies

[symbol]

EKr, g [symbol] ≥(PgP−η(n, f)·\sqrt{d}·σ)·PgP=(1−sin α)·PgP².

To sum up, condition (i) of the (α, f)-Byzantine resilience property holds. We now focus on condition (ii).

$$EP Kr {P}^{r} = {\sum }_{correct i} E {‖ {V}_{i} ‖}^{r} \vert ( {i}_{*} = i ) + {\sum }_{byz k} E {‖ {B}_{k} ‖}^{r} \vert ( {i}_{*} = k ) \leq ( n - f ) E {‖ G ‖}^{r} + {\sum }_{byz k} E {‖ {B}_{k} ‖}^{r} \vert ( {i}_{*} = k ) .$$

Denoting by C a generic constant, when iₒ=k, we have for all correct indices i

$$‖ {B}_{k} - \frac{1}{{δ}_{c} ( k )} {\sum }_{k \to correct j} {V}_{j} ‖ \leq \sqrt{\frac{1}{{δ}_{c} ( k )} {\sum }_{i \to correct j} {‖ {V}_{i} - {V}_{j} ‖}^{2} + \frac{{δ}_{b} ( i )}{{δ}_{c} ( k )} {‖ {V}_{i} - {V}_{ζ ( i )} ‖}^{2}} \leq C \cdot ( \sqrt{\frac{1}{{δ}_{c} ( k )}} \cdot {\sum }_{i \to correct j} ‖ {V}_{i} - {V}_{j} ‖ + \sqrt{\frac{{δ}_{b} ( i )}{{δ}_{c} ( k )}} \cdot ‖ {V}_{i} - {V}_{ζ ( i )} ‖ ) \leq C \cdot {\sum }_{correct j} ‖ {V}_{j} ‖ ( triangularinequality ) .$$

The second inequality comes from the equivalence of norms in finite dimension. Now

$$‖ {B}_{k} ‖ \leq ‖ {B}_{k} - \frac{1}{{δ}_{c} ( k )} {\sum }_{k \to correctj} {V}_{j} ‖ + ‖ \frac{1}{{δ}_{c} ( k )} {\sum }_{k \to correctj} {V}_{j} ‖ \leq C \cdot {\sum }_{correctj} ‖ {V}_{j} ‖$$

$${‖ {B}_{k} ‖}^{τ} \leq C \cdot {\sum }_{{r}_{1} + ⋯ + {r}_{n - f} = τ} {‖ {V}_{1} ‖}^{{r}_{1}} ⋯ {‖ {V}_{n - f} ‖}^{{r}_{n - f}}$$

Since the Vᵢ's are independent, we finally obtain that E∥Kr∥^{r} is bounded above by a linear combination of terms of the form [symbol] ∥V₁∥^{r}^{₁} . . . [symbol] ∥V_{n-f}∥^{r}^{_{n−f}}= [symbol] ∥G∥^{r}^{₁} . . . [symbol] ∥G∥^{r}^{_{n−f}} with r₁+ . . . +r_{n-f}=r. This completes the proof of condition (ii).

Convergence Analysis

In the following, the convergence of the SGD using the Krum function defined above is analyzed. The SGD equation is expressed as follows

xₜ₊₁=xₜ−λₜ·KR(V₁^{t}, . . . , Vₙ^{t})

where at least n−f vectors among the Vᵢ^{t}'s are correct, while the other ones may be Byzantine. For a correct index i, Vᵢ^{t}=G(x₁, ξ₁^{t}) where G is the gradient estimator. We define the local standard deviation σ(x) by

d·σ²(x)=E∥G(x, ξ)−∇Q(x)∥².

The following proposition considers an (a priori) non-convex cost function. In the context of non-convex optimization, even in the centralized case, it is generally hopeless to aim at proving that the parameter vector xₜ tends to a local minimum. Many criteria may be used instead. We follow reference [2], and we prove that the parameter vector xᵢ almost surely reaches a “flat” region (where the norm of the gradient is small), in a sense explained below.

Proposition 2.We assume that (i) the cost function Q is three times differentiable with continuous derivatives, and is non-negative, Q(x)≤0; (ii) the learning rates satisfy Σₜγₜ=∞ and Σₜγₜ²<∞; (iii) the gradient estimator satisfies [symbol] G(x, ξ)=∇Q(x) and ∀r∈{2, . . . , 4}, [symbol] ∥G(x, ξ)∥^{r}≤Aᵣ+Bᵣ∥x∥^{r} for some constants Aᵣ, Bᵣ; (iv) there exists a constant 0≤α<π/2 such that for all X

η(n, f)·\sqrt{d}·σ(x)≤P∇Q(x)P·sin α;

(v) finally, beyond a certain horizon, PxP²≥D, there exist ϵ>0 and 0≤β<π/2−α such that

$$‖ ∇ Q ( x ) ‖ \geq ɛ > 0 and \frac{〈 x , ∇ Q ( x ) 〉}{PxP \cdot P ∇ Q ( x ) P} \geq cos β .$$

Then the sequence of gradients ∇Z(xₜ) converges almost surely to zero.

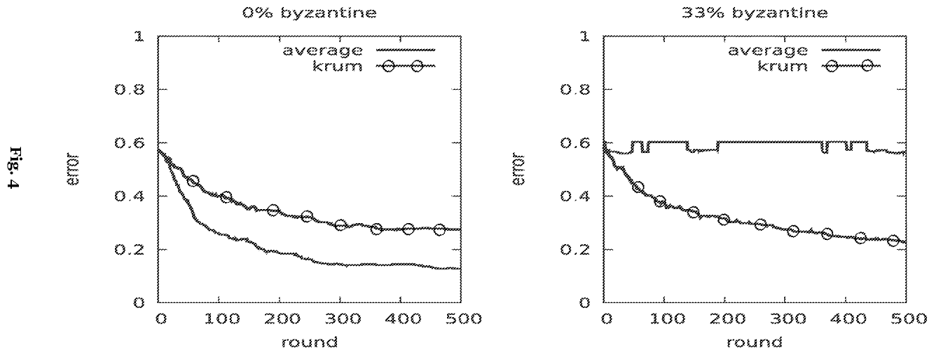

FIG. 3 illustrates the condition on the angles between xₜ, ∇Q(xₜ) and EKrₜ, in the region PxₜP²>D.

Conditions (i) to (iv) are the same conditions as in the non-convex convergence analysis in reference [3]. Condition (v) is a slightly stronger condition than the corresponding one in reference [3], and states that, beyond a certain horizon, the cost function Q is “convex enough”, in the sense that the direction of the gradient is sufficiently close to the direction of the parameter vector X. Condition (iv), however, states that the gradient estimator used by the correct workers has to be accurate enough, i.e., the local standard deviation should be small relatively to the norm of the gradient. Of course, the norm of the gradient tends to zero near, e.g., extremal and saddle points. Actually, the ratio η(n, f)·\sqrt{d}·σ∥∇Q∥ controls the maximum angle between the gradient ∇Q and the vector chosen by the Krum function. In the regions where ∥∇Q∥<η(n, f)·\sqrt{d}·σ, the Byzantine workers may take advantage of the noise (measured by σ) in the gradient estimator G to bias the choice of the parameter server. Therefore, Proposition 2 is to be interpreted as follows: in the presence of Byzantine workers, the parameter vector xₜ almost surely reaches a basin around points where the gradient is small (∥∇Q∥≤η(n, f)·\sqrt{d}·σ), i.e., points where the cost landscape is “almost flat”.

Note that the convergence analysis is based only on the fact that function Kr is (α, f)-Byzantine resilient.

The complete proof of Proposition 2 is as follows:

Proof. For the sake of simplicity, we write KRₜ=KR(V₁^{t}, . . . , Vₙ^{t}). Before proving the main claim of the proposition, we first show that the sequence xₜ is almost surely globally confined within the region PxP²≤D.

### (Global Confinement).

$$Let {u}_{t} = φ ( {Px}_{t} {P}^{2} ) where φ ( a ) = \{ \begin{matrix}0 & if a < D \\ {( a - D )}^{2} & otherwise\end{matrix}$$

Note that

ϕ(b)−ϕ(a)≤(b−a)ϕ′(a)+(b−a)². (1)

This becomes an equality when a,b≥D. Applying this inequality to uₜ₊₁−uₜ yields

uₜ₊₁−uₜ≤(−2γₜ [symbol] xₜ, KRₜ [symbol] +γₜ²PKr,P²)·ϕ′(PxₜP²)+4γₜ² [symbol] xₜ, Krₜ [symbol] ²−4γₜ³ [symbol] xₜ, Krₜ [symbol] PKrₜP²+γₜ⁴PKrₜP⁴≤−2γₜ [symbol] xₜ, Krₜ [symbol] ϕ′(PxₜP²)+γₜ²PKrₜP²ϕ′(PxₜP²)+4γₜ²PxₜP²PKrₜP²+4γₜ³PxₜPPKrₜP³+γₜ⁴PKrₜP⁴.

Let Pₜ denote the σ-algebra encoding all the information up to round t. Taking the conditional expectation with respect to Pₜ yields

E(uₜ₊₁−uₜ|Pₜ)≤−2γₜ [symbol] xₜ, EKrₜ [symbol] +γₜ²E(PKrₜP²)ϕ′(PxₜP²)+4γ₆²PxₜP²E(PKrₜP²)+4γₜ³PxₜPE(PKrₜP³)+γₜ⁴E(PKrₜP⁴).

Thanks to condition (ii) of (α, f)-Byzantine resilience, and the assumption on the first four moments of G, there exist positive constants A₀, B₀ such that

E(uₜ₊₁−uₜ|Pₜ)≤−2γₜ [symbol] xₜ, EKrₜ [symbol] ′(PxₜP²)+γₜ²(A₀+B₀PxₜP⁴).

Thus, there exist positive constant A, B such that

E(uₜ₊₁−uₜ|Pₜ)≤−2γₜ [symbol] xᵢ, EKrₜ [symbol] ϕ′(PxₜP²)+γₜ²(A+B·uₜ).

When PxₜP²<D, the first term of the right hand side is null because ϕ′(PxₜP²)=0. When PxₜP²≥D, this first term is negative because (see FIG. 3)

[symbol]

xₜ, EKrₜ [symbol] ≥PxₜP·PEKrₜP·cos(α+β)>0.

Hence

E(uₜ₊₁−uₜ|Pₜ)≤γₜ²(A+B·uᵢ).

We define two auxiliary sequences

$${μ}_{t} = {\prod }_{i = 1}^{t} \frac{1}{1 - {γ}_{i}^{2} B} {\to }_{t \to ∞} {μ}_{∞}$$

$${u}_{t}^{′} = {μ}_{l} {μ}_{t} .$$

Note that the sequence uₜ converges because Σₜγₜ²<∞. Then

E(u′ᵢ₊₁−u′ᵢ∥Pᵢ)≤γₜ²μᵢA.

Consider the indicator of the positive variations of the left-hand side

$${χ}_{t} = \{ \begin{matrix}1 & if E ( {u}_{t + 1}^{′} - {u}_{t}^{′} \vert {P}_{t} ) > 0 \\ 0 & otherwise\end{matrix} \\ Then \\ E ( {χ}_{t} \cdot ( {u}_{t + 1}^{′} - {u}_{t}^{′} ) ) \leq E ( {χ}_{t} \cdot E ( {u}_{t + 1}^{′} - {u}_{t}^{′} \vert {P}_{t} ) ) \leq {γ}_{t}^{2} {μ}_{t} A .$$

The right-hand side of the previous inequality is the summand of a convergent series. By the quasi-martingale convergence theorem (see reference [2]), this shows that the sequence u′ᵢ converges almost surely, which in turn shows that the sequence uᵢ converges almost surely, uᵢ→u_{∞}≥0.

Let us assume that u_{∞}>0. When t is large enough, this implies that PxₗP² and Pxₗ₊₁P² are greater than D . Inequality 1 becomes an equality, which implies that the following infinite sum converges almost surely

$${\sum }_{t = 1}^{∞} {γ}_{t} 〈 {x}_{t} , {EKr}_{t} 〉 {φ}^{′} ( {Px}_{t} {P}^{2} ) < ∞ .$$

Note that the sequence ϕ′(PxₜP²) converges to a positive value. In the region PxₜP²>D, we have

[symbol]

xₜ, EKrₜ [symbol] ≥\sqrt{D}·∥EKrₜ∥·cos(α+β)≥\sqrt{D}·(∥∇Q(xₜ)∥−η(n, f)·\sqrt{d}·σ(xₜ))·cos(α+β)≥\sqrt{D}·ϵ·(1−sin α)·cos(α+β)>0.

This contradicts the fact that Σ_{t∞1}^{∞}γₜ=∞. Therefore, the sequence uₜ converges to zero. This convergence implies that the sequence PxᵢP² is bounded, i.e., the vector xₜ is confined in a bounded region containing the origin. As a consequence, any continuous function of xᵢ is also bounded, such as, e.g., PxₜP², E∥G(xₜ, ξ)∥² and all the derivatives of the cost function Q(xₜ). In the sequel, positive constants K₁, K₂, etc are introduced whenever such a bound is used.

### (Convergence).

We proceed to show that the gradient ∇Q(xₜ) converges almost surely to zero. We define

hₜ=Q(xₜ).

Using a first-order Taylor expansion and bounding the second derivative with K₁, we obtain ∥hₜ₊₁−hₜ+2γₜ [symbol] Krₜ, ∇Q(xₜ) [symbol] ≤γₜ²PKrₜP²K₁a.s.

### Therefore

E(hₜ₊₁−hₜ∥Pₜ)≤−2γₜ [symbol] EKrₜ, ∇Q(xₜ) [symbol] +γₜ²E(PKrₜP²∥Pₜ)K₁. (2)

By the properties of (α, f)-Byzantine resiliency, this implies

E(hₜ₊₁−hₜ∥Pₜ)≤γₜ², K₂K₁,

which in turn implies that the positive variations of hₜ are also bounded

E(χₜ·(hₜ₊₁−hₜ))≤γₜ²K₂K₁.

The right-hand side is the summand of a convergent infinite sum. By the quasi-martingale convergence theorem, the sequence hₜ converges almost surely, Q(xₜ)→Q_{∞}.

Taking the expectation of Inequality 2, and summing on t=1, . . . ∞, the convergence of Q(xₜ) implies that

$${\sum }_{t = 1}^{∞} {γ}_{t} 〈 {EKr}_{t} , ∇ Q ( {x}_{t} ) 〉 < ∞ a . s .$$

We now define

ρₜ=∥∇Q(xₜ)∥².

Using a Taylor expansion, as demonstrated for the variations of hₜ, we obtain

ρ_{t⇄1}−ρₜ≤−2γₜ [symbol] Krₜ, (∇²Q(xₜ))·∇Q(xₜ) [symbol] +γₜ²∥Krₜ∥² K₃a.s.

Taking the conditional expectation, and bounding the second derivatives by K₄,

E(ρₜ₊₁−ρₜ∥Pₜ)≤2γₜ [symbol] EKrₜ, ∇Q(xₜ) [symbol] K₄+γ²K₂K₃.

The positive expected variations of ρₜ are bounded

E(χₜ·(ρₜ₊₁−ρ))≤2γₜE [symbol] EKrₜ⇄Q(xₜ) [symbol] K₄+γₜ²K₂K₃.

The two terms on the right-hand side are the summands of convergent infinite series. By the quasi-martingale convergence theorem, this shows that ρₜ converges almost surely. We have

$$〈 𝔼 {KR}_{t} , ∇ Q ( {x}_{t} ) 〉 \geq ( ‖ ∇ Q ( {x}_{t} ) ‖ - η ( n , f ) \cdot \sqrt{d} \cdot σ ( {x}_{t} ) ) \cdot ‖ ∇ Q ( {x}_{t} ) ‖ \geq \underbrace{( 1 - sin α )}_{> 0} \cdot {ρ}_{t} .$$

This implies that the following infinite series converge almost surely

$${\sum }_{t = 1}^{∞} {γ}_{t} \cdot {ρ}_{t} < ∞ .$$

Since ρₜ converges almost surely, and the series Σ_{t√1}^{∞}γₜ=∞ diverges, we conclude that the sequence P∇Q(xₜ)P converges almost surely to zero.

### Experimental Evaluation

The following is an evaluation of the convergence and resilience properties of Krum, as well as variants of Krum.

### Resilience to Byzantine Processes

We consider the task of spam filtering (based on the dataset spambase of reference [19]) as an exemplary application of the concepts disclosed herein. The learning model is a multi-layer perceptron (MLP) with two hidden layers. There are n=20 worker processes. Byzantine processes propose vectors drawn from a Gaussian distribution with mean zero, and isotropic covariance matrix with standard deviation 200. We refer to this behavior as Gaussian Byzantine. Each (correct) worker estimates the gradient on a mini-batch of size 3. We measure the error using cross-validation. FIG. 4 shows how the error (y-axis) evolves with the number of rounds (x-axis).

FIG. 4 illustrates a cross-validation error evolution with rounds, respectively in the absence and in the presence of 33% Byzantine workers. The mini-batch size is 3. With 0% Gaussian Byzantine workers, averaging converges faster than Krum. With 33% Gaussian Byzantine workers, averaging does not converge, whereas Krum behaves as if there were 0% Byzantine workers. This experiment confirms that averaging does not tolerate (the rather mild) Gaussian Byzantine behavior, whereas Krum does.

### The Cost of Resilience

As seen above, Krum slows down learning when there are no Byzantine workers. The following experiment shows that this overhead can be significantly reduced by slightly increasing the mini-batch size. To highlight the effect of the presence of Byzantine workers, the Byzantine behavior has been set as follows: each Byzantine worker computes an estimate of the gradient over the whole dataset (yielding a very accurate estimate of the gradient), and proposes the opposite vector, scaled to a large length. We refer to this behavior as omniscient.

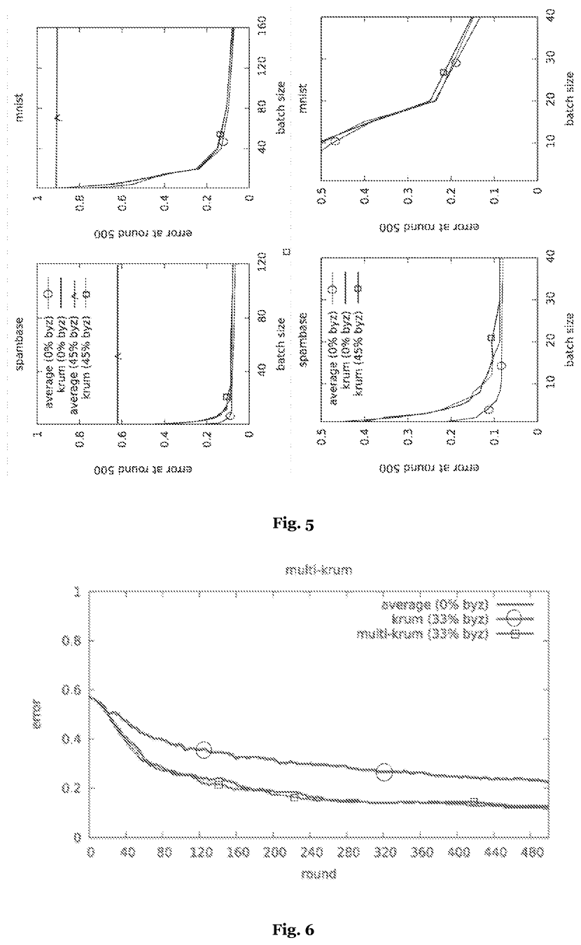

FIG. 5 illustrates how the error value at the 500-th round (y-axis) evolves when the mini-batch size varies (x-axis). In this experiment, we consider the tasks of spam filtering (dataset spambase) and image classification (dataset MNIST). The MLP model is used in both cases. Each curve is obtained with either 0 or 45% of omniscient Byzantine workers. In all cases, averaging still does not tolerate Byzantine workers, but yields the lowest error when there are no Byzantine workers. However, once the size of the mini-batch reaches the value 20, Krum with 45% omniscient Byzantine workers is as accurate as averaging with 0% Byzantine workers. We observe a similar pattern for a ConvNet as provided in the supplementary material.

### Multi-Krum

Krum as presented above selects only one vector among the vectors proposed by the workers. Multi-Krum, by contrast, computes for each vector proposed, the score as in the Krum function above. Then, Multi-Krum selects the m∈{1, . . . n} vectors V*₁, . . . V*ₘ which score the best, and outputs their average

$$\frac{1}{m} {Σ}_{i} {V}_{i}^{*} .$$

Note that, the cases m=1 and m=n correspond to Krum and averaging respectively.

FIG. 6 shows how the error (y-axis) evolves with the number of rounds (x-axis). In the figure, we consider the task of spam filtering (dataset spambase), and the MLP model. The Multi-Krum parameter m is set to m=n−f. FIG. 6 shows that Multi-Krum with 33% Byzantine workers is as efficient as averaging with 0% Byzantine workers.

From the practitioner's perspective, the parameter m may be used to set a specific trade-off between convergence speed and resilience to Byzantine workers.

### Medoid-Krum

This aggregation rule is an easily computable variant of the geometric median. As discussed above, the geometric median is known to have strong statistical robustness, however there exists no algorithm yet (see reference [1]) to compute its exact value.

Recall that the geometric median of a set of d-dimensional vectors V₁, . . . , Vₙ is defined as follows:

$$med ( {V}_{1} , … , {V}_{n} ) = arg {min}_{x ∈ {ℝ}^{d}} {\sum }_{i = 1}^{n} ‖ {V}_{i} - x ‖$$

The geometric median does not necessarily lie among the vectors V₁, . . . Vₙ. A computable alternative to the median are the medoids, which are defined as follows:

$$medoids ( {V}_{1} , … , {V}_{a} ) = arg {min}_{x ∈ \{ {V}_{1} , … , {V}_{n} \}} {\sum }_{i = 1}^{n} ‖ {V}_{i} - x ‖ .$$

As a medoid is not unique, similarly to Krum, if more than a vector minimizes the sum, we will refer to the Medoid as the medoid with the smallest index.

### 1−p Krum

In this aggregation rule, the parameter server chooses the average of the proposed vectors with probability p, and Krum with probability 1−p. Moreover, we choose p to depend on the learning round. In a preferred implementation

$${p}_{t} = \frac{1}{\sqrt{t}} ,$$

where t is the round number. With such a probability, and despite the presence of Byzantine workers, 1−p Krum has a similar proof of convergence as Krum: the probability of choosing Krum goes to 1 when t→∞. The rational is to follow averaging in the early phases, to accelerate learning in the absence of Byzantine workers, while mostly following Krum in the later phases and guarantee Byzantine resilience. Remember that the parameter server never knows if there are Byzantine workers or not. The latter can behave like correct workers in the beginning and fool any fraud detection measure.

### Experimental Details and Additional Results

The concepts underlying the present invention have been evaluated on a distributed framework where we set some nodes to have an adversarial behavior of two kinds:

(a) The omniscient Byzantine workers: workers have access to all the training-set (as if they breached into the other workers share of data). Those workers compute a rather precise estimator of the true gradient, and send the opposite value multiplied by an arbitrarily large factor.

(b) The Gaussian Byzantine workers: Byzantine workers do not compute an estimator of the gradient and send a random vector, drawn from a Gaussian distribution of which we could set the variance high enough (200) to break averaging strategies.

On this distributed framework, we train two models with non-trivial (a-priori non-Convex) loss functions: a 4-layer convolutional network (ConvNet) with a final fully connected layer, and a classical multilayer perceptron (MLP) with two hidden layers, and on two tasks: spam filtering and image classification. We use cross-validation accuracy to compare the performance of different algorithms. The focus is on the Byzantine resilience of the gradient aggregation rules and not on the performance of the models per se.

### Replacing an MLP by a ConvNet

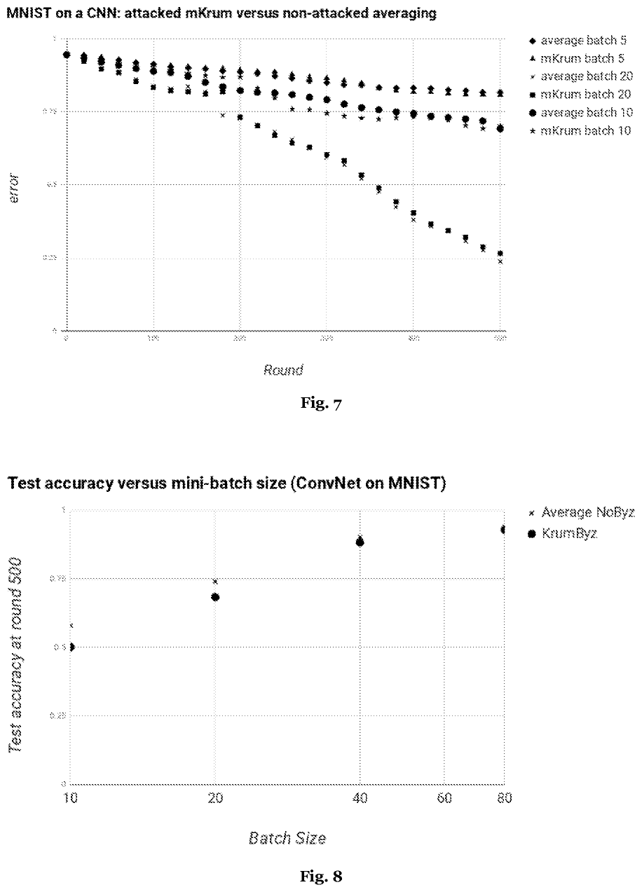

FIG. 7 shows that, similarly to the situation on an MLP, mKrum (Multi-Krum) is, despite attacks, comparable to a non-attacked averaging.

More precisely, FIG. 7 compares an averaging aggregation with 0% Byzantine workers to mKrum facing 45% omniscious Byzantine workers for the ConvNet on the MNIST dataset. The cross-validation error evolution during learning is plotted for 3 sizes of the size of the mini-batch.

In the same veine, in FIG. 8, it can be seen that like for an MLP, the ConvNet only requires a reasonably low batch size for Krum to perform (despite 45% Byzantine workers) as good as a non-attacked averaging.

More precisely, FIG. 8 illustrates a test accuracy after 500 rounds as a function of the mini-batch size for an averaging aggregation with 0% Byzantine workers for the

ConvNet on the MNIST dataset versus mKrum facing 45% of omniscious Byzantine workers.

### Optimizing Krum

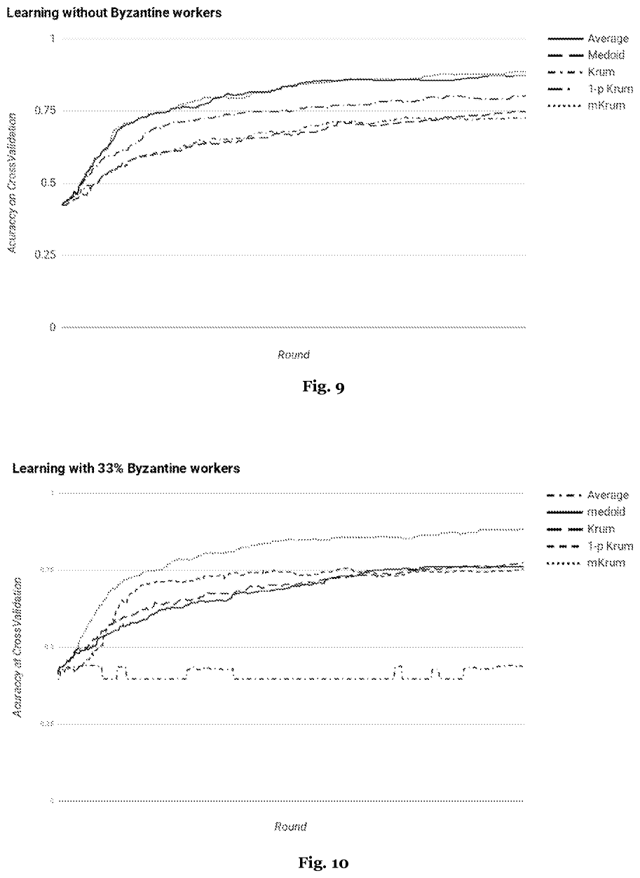

FIG. 9 compares the different variants in the absence of Byzantine workers. As can be seen, Multi-Krum is comparably fast to averaging, then comes 1−p Krum, while Krum and the Medoid are slower. In more detail, FIG. 9 illustrates the evolution of cross-validation accuracy with rounds for the different aggregation rules in the absence of Byzantine workers. The model is the MLP and the task is spam filtering. The mini-batch size is 3. Averaging and mKrum are the fastest, 1−p Krum is second, Krum and the Medoid are the slowest.

In the presence of Byzantine workers (FIG. 10), Krum, Medoid and 1−p Krum are similarly robust. Unsurprisingly, averaging is not resilient (no improvement over time). Multi-Krum outperforms all the tested aggregation rules. More precisely, FIG. 10 shows the evolution of cross-validation accuracy with rounds for the different aggregation rules in the presence of 33% Gaussian Byzantine workers. The model is the MLP and the task is spam filtering. The mini-batch size is 3. Multi-Krum (mKrum) outperforms all the tested aggregation rules.

### Additional Aspects of Embodiments of the Invention

### The Distributed Computing Perspective

Although seemingly related, results in d-dimensional approximate agreement (see references [24, 14]) cannot be applied to our Byzantine-resilient machine context for the following reasons: (a) references [24, 14] assume that the set of vectors that can be proposed to an instance of the agreement is bounded so that at least f+1 correct workers propose the same vector, which would require a lot of redundant work in our setting; and more importantly, (b) reference [24] requires a local computation by each worker that is in O(n^{d}). While this cost seems reasonable for small dimensions, such as, e.g., mobile robots meeting in a 2D or 3D space, it becomes a real issue in the context of machine learning, where d may be as high as 160 billion (see reference [30]) (making d a crucial parameter when considering complexities, either for local computations, or for communication rounds). The expected time complexity of the Krum function is O(n²·d). A closer approach to the presently proposed one has been recently proposed in references [28, 29]. In reference [28], the study only deals with parameter vectors of dimension one, which is too restrictive for today's multi-dimensional machine learning. In reference [29], the authors tackle a multi-dimensional situation, using an iterated approximate Byzantine agreement that reaches consensus asymptotically. This is however only achieved on a finite set of possible environmental states and cannot be used in the continuous context of stochastic gradient descent.

### The Statistics and Machine Learning View

Embodiments of the invention build in part upon the resilience of the aggregation rule (see reference [11]) and theoretical statistics on the robustness of the geometric median and the notion of breakdown (see reference [7]). For example, the maximum fraction of Byzantine workers that can be tolerated, i.e.

$$\frac{n - 2}{2 n} ,$$

reaches the optimal theoretical value (½) asymptotically on n. It is known that the geometric median does achieve the optimal breakdown. However, no closed form nor an exact algorithm to compute the geometric median is known (only approximations are available; see reference [5]; and their Byzantine resilience is an open problem). An easily computable variant of the median is the Medoid, which is the proposed vector minimizing the sum of distances to all other proposed vectors. The Medoid can be computed with a similar algorithm to Krum.

### Robustness Within the Model

It is important to keep in mind that embodiments of the present invention deal with robustness from a coarse-grained perspective: the unit of failure is a worker, receiving its copy of the model and estimating gradients, based on either local data or delegated data from a server. The nature of the model itself is less important, the distributed system can be training models spanning a large range from simple regression to deep neural networks. As long as this training is using gradient-based learning, the proposed algorithm to aggregate gradients, Krum, provably ensures convergence when a simple majority of nodes are not compromised by an attacker.

A natural question to consider is the fine-grained view: is the model itself robust to internal perturbations? In the case of neural networks, this question can somehow be tied to neuroscience considerations: could some neurons and/or synapses misbehave individually without harming the global outcome? We formulated this question in another work and proved a tight upper bound on the resulting global error when a set of nodes is removed or is misbehaving (see reference [9]). One of the many practical consequences (see reference [8]) of such fine-grained view is the understanding of memory cost reduction trade-offs in deep learning. Such memory cost reduction can be viewed as the introduction of precision errors at the level of each neuron and/or synapse (see reference [9]).

Other approaches to robustness within the model tackled adversarial situations in machine learning with a focus on adversarial examples (during inference; see references [10, 32, 11]) instead of adversarial gradients (during training) as Krum does. Robustness to adversarial input can be viewed through the fine-grained lens we introduced in reference [9], for instance, one can see perturbations of pixels in the inputs as perturbations of neurons in layer zero. It is important to note the orthogonality and complementarity between the fine-grained (model/input units) and the coarse-grained (gradient aggregation) approaches. Being robust, as a model, either to adversarial examples or to internal perturbations, does not necessarily imply robustness to adversarial gradients during training. Similarly, being distributively trained with a robust aggregation scheme such as Krum does not necessarily imply robustness to internal errors of the model or adversarial input perturbations that would occur later during inference. For instance, the algorithm provided in the present invention is agnostic to the model being trained or the technology of the hardware hosting it, as long as there are gradients to be aggregated.

1. A computer-implemented method for training a machine learning model using Stochastic Gradient Descent, SGD, wherein the method is performed by a first computer in a distributed computing environment and comprises:
performing a learning round, comprising:
broadcasting a parameter vector to a plurality of worker computers in the distributed computing environment;
receiving an estimate vector from all or a subset of the worker computers, wherein each received estimate vector is either an estimate of a gradient of a cost function, or an erroneous vector; and
determining an updated parameter vector for use in a next learning round based only on a subset of the received estimate vectors.

2. The method of claim 1, wherein, if the first computer has not received an estimate vector from a given worker computer, the first computer uses a default estimate vector for the given worker computer.

3. The method of claim 1 or 2, wherein determining the updated parameter vector precludes the estimate vectors which have a distance greater than a predefined maximum distance to the other estimate vectors.

4. The method of any of the preceding claims, wherein determining the updated parameter vector comprises computing a score for each worker computer, the score representing the sum of distances, preferably squared distances, of the estimate vector of the worker computer to a predefined number of its closest estimate vectors.

5. The method of the preceding claim, wherein n is the total number of worker computers, f is the number of erroneous worker computers returning an erroneous estimate vector, and the predefined number of closest estimate vectors is n−f.

6. The method of any of the preceding claims 4 or 5, wherein for each worker computer i, the score is computed as s(i)=Σ_{i→j}∥Vᵢ−Vⱼ∥², wherein the sum runs over the n−f−2 closest vectors to Vᵢ, wherein n is the total number of worker computers, wherein f is the number of erroneous worker computers returning an erroneous estimate vector, and wherein i→j denotes the fact that an estimate vector Vⱼ belongs to the n−f−2 closest estimate vectors to Vᵢ.

7. The method of any of the preceding claims ₄ or ₅, wherein for each worker computer i, the score is computed as s(i)=Σ_{i→j}∥Vᵢ−Vⱼ∥², wherein the sum runs over the n−f−k closest vectors to Vᵢ, wherein k is a predefined integer that can take values from −f−1 to +n−f−1, wherein n is the total number of worker computers, wherein f is the number of erroneous worker computers returning an erroneous estimate vector, and wherein i→j denotes the fact that an estimate vector Vⱼ belongs to the n−f−2 closest estimate vectors to Vᵢ.

8. The method of any of the preceding claims 4 or 5, wherein for each worker computer i, the score is computed as
$$s ( i ) = \frac{1}{K ( i )} {\sum }_{i -> j} {‖ {V}_{i} - {V}_{j} ‖}^{a} ,$$
wherein a is a predefined positive integer and K(i) is a normalization factor, wherein n is the total number of worker computers, wherein f is the number of erroneous worker computers returning an erroneous estimate vector, and wherein i→j denotes the fact that an estimate vector Vⱼ belongs to the n−f−2 closest estimate vectors to Vᵢ.

9. The method of any of the preceding claims ₄-8, further comprising: selecting the estimate vector of the worker computer having the minimal score.

10. The method of the preceding claim, further comprising: if two or more worker computers have the minimal score, selecting the estimate vector of the worker computer having the smallest identifier. ii. The method of any of the preceding claims 4-8, further comprising:
selecting two or more of the estimate vectors which have the smallest scores; and
computing the average of the selected estimate vectors.

12. The method of the preceding claim, wherein the number of selected estimate vectors is selected to set a trade-off between convergence speed and resilience to erroneous worker computers.

13. The method of the preceding claim, wherein the number of selected estimate vectors is n−f, wherein n is the total number of worker computers and f is the number of erroneous worker computers returning an erroneous estimate vector.

14. The method of any of the preceding claims, wherein determining the updated parameter vector comprises computing the Medoid of the received estimate vectors, or a variant of the Medoid comprising minimizing the sum of non-squared distances over a subset of neighbors of a predetermined size.

15. The method of any of the preceding claims, wherein determining the updated parameter vector comprises computing the average of the received estimate vectors with a probability p or selecting the received estimate vector that minimizes the sum of squared distances to a predetermined number of closest estimate vectors with a probability 1−p, wherein p decreases with each learning round.

16. The method of any of the preceding claims, wherein the machine learning model comprises a neural network, regression, matrix factorization, support vector machine and/or any gradient-based optimizable learning model.

17. The method of any of the preceding claims, wherein the method is used for training a spam filter, email filtering, recommender system, natural language processing, detection of network intruders or malicious insiders working towards a data breach, optical character recognition (OCR), computer vision, pattern recognition, image classification and/or artificial intelligence.

18. A computer in a distributed computing environment, adapted for performing a method in accordance to any of the preceding claims.

19. A computer in a distributed computing environment for training a machine learning model using Stochastic Gradient Descent, SGD, wherein the computer comprises:
a processor configured for performing a learning round, comprising:
broadcasting a parameter vector to a plurality of worker computers in the distributed computing environment;
receiving an estimate vector from all or a subset of the worker computers, wherein each received estimate vector is either an estimate of a gradient of a cost function, or an erroneous vector; and
determining an updated parameter vector for use in a next learning round based only on a subset of the received estimate vectors.

20. A distributed computing environment, comprising:
a first computer according to claim 18 or 19; and
a plurality of worker computers.

21. A computer program comprising instructions for implementing a method in accordance with any of the claims 1-17.

22. A non-transitory computer-readable medium comprising code that, when executed, causes a first computer of a distributed computing environment to:
perform a learning round, comprising:
broadcasting a parameter vector to a plurality of worker computers in the distributed computing environment;
receiving an estimate vector from all or a subset of the worker computers, wherein each received estimate vector is either an estimate of a gradient of a cost function, or an erroneous vector; and
determining an updated parameter vector for use in a next learning round based only on a subset of the received estimate vectors.
